(19) United States
(12) Patent Application Publication
(10) Pub. No.: US 2022/0289373 A1
(43) Pub. Date: Sep. 15, 2022

(54) MANAGEMENT APP FOR DRONE WITH REMOTE ID

(71) Applicant: Sony Interactive Entertainment Inc., Tokyo (JP)

(72) Inventor: Dennis Castleman, San Mateo, CA (US)

(21) Appl. No.: 17/201,841

(22) Filed: Mar. 15, 2021

(51) Int. Cl. B64C 39/02; G06F 3/14; G08C 17/02; H04N 7/18; G08B 5/22; G05D 1/00

(52) U.S. Cl. CPC B64C 39/024; G06F 3/14; G08C 17/02; H04N 7/185; G08B 5/22; G05D 1/0016; B64C 2201/146

(57) ABSTRACT

A global positioning satellite (GPS) receiver and a transmitter are at a base remote from a drone, and the transmitter sends GPS packets along with control packets to the drone. In turn, the drone also has a GPS receiver and a transmitter that transmits both the controller and drone GPS coordinates to the remote base. A management app for law enforcement is provided.

### FIELD

The present application relates to technically inventive, non-routine solutions that are necessarily rooted in computer technology and that produce concrete technical improvements.

### BACKGROUND

As understood herein, airborne drones are becoming increasingly popular for a wide variety of uses.

### SUMMARY

Accordingly, present principles may be applied both to virtual reality (VR) drones and physical drones, and to mixed reality settings that may use both.

As further understood herein, it may be possible that regulatory agencies will require physical drones to have a remote identification function. Present principles are directed to a global positioning satellite (GPS) receiver in a drone control device that is remote from the drone. The drone control device also includes a transmitter that sends GPS packets along with control packets to the drone. In turn, the drone also has a GPS receiver and a transmitter that transmits both the controller and drone GPS coordinates.

In addition to location information, the data sent by the drone may also include drone ID, drone altitude, drone velocity, drone control device elevation, a time mark, and the emergency status, if any, of the drone.

Accordingly, in one aspect an assembly includes at least one computer storage that is not a transitory signal and that in turn includes instructions executable by at least one processor to present on at least one display at least one user interface (UI). The UI includes at least one drone icon indicating at least a real time location of at least a first unmanned airborne drone. The instructions are executable to present on the UI at least one operator icon indicate at least a real time location of a respective first controller of the first drone, and to present on the UI at least one warning selector selectable to enable the viewer to enter at least one message to be sent to at least the first controller.

In some examples the instructions can be executable to present on the UI visible indication correlating the drone icon and the respective operator icon. The visible indication can include at least a portion of a line.

In non-limiting embodiments the instructions are executable to present on the UI an origin indication to indicate a location of a viewer of the display, and present on the UI plural drone icons representing respective drones within a distance of the origin and not presenting icons representing drones beyond the distance. The instructions may be executable to present on the UI at least a first selector selectable to establish the distance.

In implementations, the instructions cam be executable to present on the UI at least one drone selector mechanism selectable to indicate a drone whose respective operator is to receive the message.

The instructions may be executable to present an indication of altitude of the first drone, and to receive drone location information from a database or from a drone.

In another aspect, an assembly includes a drone controller with at least one location sensor and at least one wireless transceiver. The drone controller is associated with at least one display and at least one controller processor. At least one drone includes at least one location sensor, at least one information transmitter, and at least one drone processor to control flight of the drone responsive to signals from the drone controller. The controller processor is programmed with instructions to present on the display at least one user interface (UI) comprising at least message regarding operation of the drone and at least one identification of an agency sending the message.

In another aspect, an assembly includes at least one computer storage that is not a transitory signal and that in turn includes instructions executable by at least one processor to present on at least one display at least one user interface (UI) presenting at least one image from at least one camera of at least a first airborne pilotless drone. The instructions are executable to receive via Bluetooth and/or Wi-Fi at least one signal from the first drone indicating at least a drone ID of the first drone, correlate the drone ID with the first drone in the image at least in part based on the image using orientation and location sensors in the mobile device, and present information associated with the drone ID on the display.

In example embodiments, the processor executing the instructions the camera may be supported on a law enforcement mobile device that includes the display.

In some implementations the instructions can be executable to present on the display at least one warning selector to enter a warning or other message to be sent to the first drone.

The information associated with the drone ID may include one or more of a picture of the first drone that is not received from the camera, altitude of the first drone, location of the first drone, and location of an operator of the first drone.

In aspects, an assembly includes at least one drone controller with at least one location sensor and at least one wireless transceiver. The assembly also includes at least one drone. The drone includes at least one location sensor, at least one information transmitter, and at least one processor to control flight of the drone responsive to signals from the drone controller. The processor is programmed with instructions to receive flight control signals from the drone controller, and control flight of the drone responsive to the flight control signals. The instructions are further executable by the processor to receive at least drone controller location information from the drone controller. The processor further is programmed to transmit, using the information transmitter, reporting signals. The reporting signals include location information from the drone controller and location information from the location sensor of the drone.

In some embodiments the reporting signals may further include one or more of time information correlated with the location information of the drone, altitude information of the drone, elevation information of the drone controller, drone ID, drone velocity, and emergency status of the drone.

In example embodiments the reporting signals can be sent from the drone via Bluetooth. In addition, or alternatively, the reporting signals can be sent from the drone via Wi-Fi. The reporting signals may be sent in packets.

In one embodiment the reporting signals may be sent from a transceiver receiving the flight control signals. In another embodiment the reporting signals can be sent from a transceiver not receiving the flight control signals.

In one embodiment the wireless transceiver of the drone controller sends both the flight control signals and drone controller location information to the drone. In another embodiment the wireless transceiver of the drone controller sends only the flight control signals, but not the drone controller location information, to the drone.

In example implementations, the processor of the drone is programmed with instructions to send the reporting signals periodically and automatically. In other example implementations, the processor of the drone is programmed with instructions to send the reporting signals only responsive to a command from an external device to transmit the reporting signals. In still other example implementations, the processor of the drone is programmed with instructions to send the reporting signals substantially continuously throughout flight of the drone. Yet again, example implementations, the processor of the drone may be programmed with instructions to send the reporting signals only responsive to the drone meeting at least one flight condition, such as attaining a particular altitude and/or speed and/or location.

In another aspect, a method includes receiving flight control information from a controller, and responsive to the flight control information, moving a control surface. The method further includes receiving controller location information from the controller, receiving drone location information from a global satellite positioning (GPS) receiver associated with the control surface, and transmitting, via Bluetooth and/or Wi-Fi, the controller location information and drone location information in a single packet stream.

In another aspect, a drone includes one or more control surface operable to control flight of the drone. The drone further includes at least one global satellite positioning (GPS) receiver, at least one radiofrequency (rf) receiver configured to receive flight control signals from a ground unit, and at least one Wi-Fi and/or Bluetooth transmitter. Additionally, the drone includes at least one processor programmed with instructions to control the control surface according to the flight control signals, transmit location information received from the GPS receiver via the Wi-Fi and/or Bluetooth transmitter, and transmit location information of the ground unit via the Wi-Fi and/or Bluetooth transmitter.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 illustrates an example system consistent with present principles;

FIG. 3 illustrates in example block diagram format components of items shown in FIG. 2;

FIG. 4 illustrates example logic in example follow chart format;

FIG. 5 illustrates an example user interface that may be presented on a monitoring device such as a law enforcement computer;

FIG. 6 illustrates an example user interface that may be presented on a device of a drone operator; and

FIG. 7 illustrates another example user interface that may be presented on a monitoring device such as a law enforcement computer.

### DETAILED DESCRIPTION

This disclosure relates generally to computer ecosystems including aspects of consumer electronics (CE) device networks such as but not limited to computer game networks including drones used for gaming or non-gaming purposes. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

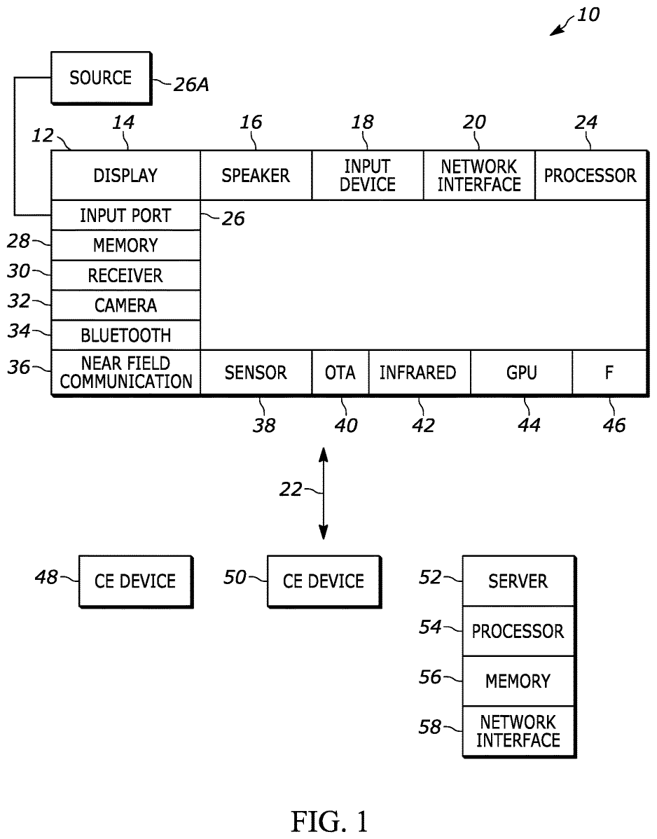

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. A graphics processor may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input ports 26 such as a high-definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 44.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimensions.

Continuing the description of the AVD 12, in some embodiments the AVD 12 may include one or more cameras 32 that may be a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a motion sensor such as an accelerometer, gyroscope, cyclometer, or a magnetic sensor, an infrared (IR) sensor, an optical sensor, a speed and/or cadence sensor, a gesture sensor (e.g., for sensing gesture command), providing input to the processor 24. The AVD 12 may include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included.

Still referring to FIG. 1, in addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other devices of FIG. 1 over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown in FIG. 1 or nearby.

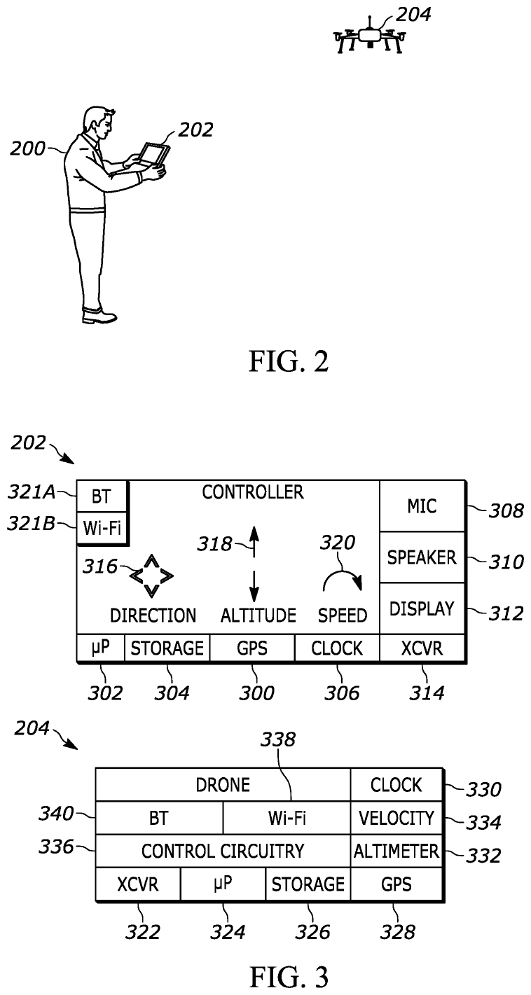

The components shown in FIG. 2 may include some or all components shown in FIG. 1.

FIG. 2 illustrates a drone system with elements that may include some or all of the appropriate components from relevant devices in FIG. 1. As shown, a person 200 may operate, via hand manipulation, voice command, eye motion, or other input means, a drone controller 202. The drone controller 202 typically is lightweight and hand-held and transmits wireless signals to one or more flying pilotless drones 204.

FIG. 3 illustrates example components that may be implemented in the drone controller 202 and drone 204 as described below and as augmented with description of FIG. 1 components where appropriate. At least one global positioning satellite (GPS) receiver 300 or other location-sensing device is incorporated in the drone controller 202. The GPS receiver typically outputs a signal representative of the latitude and longitude of the controller 202, as well as its elevation. The signal from the GPS receiver 300 is provided to one or more processors 302 of the controller 202 accessing one or more computer storages 304 to execute logic herein. The processor 302 also may receive time input from a computer clock 306. The processor 302 may receive voice-originated input signals from one or more microphones 308 and may output information such as acoustic and visual representation of drone flight on one or more speakers 310 and one or more computer displays 312. The processor 302 may send flight control commands to the drone 204 via one or more radiofrequency (RF) wireless transceivers 314 operating at, e.g., 2.4 GHz and/or 5.8 Ghz.

Also, in FIG. 3 the example controller 202 is illustrated with manual control elements, including flight direction elements 316, drone altitude control elements 318, and drone speed control elements 320. The control elements 316, 318, 320 may be manipulated to input direction, altitude, and speed commands, respectively, to the drone 204. These commands also may be input orally through the microphone 308.

If the GPS receiver 300 outputs location only and not elevation, elevation can be obtained by the processor 302 by accessing an electronic database or map and correlating location to elevation.

The drone controller 202 also may include additional wireless transmitters, such as one or more Bluetooth transceivers 321A and/or one or more Wi-Fi transceivers 321B.

Turning to example components of the drone 204, a transceiver 322 that is configured complementarily to the rf transceiver 314 of the drone controller 202 receives wireless commands from the controller 202 and provides the commands to one or more processors 324 accessing one or more computer storages 326 in the drone 204 to execute logic consistent with present principles. The drone processor 324 also receives input from one or more location sensors such as one or more GPS receivers 328 along with time information from one or more computer clocks 330.

The GPS receiver 328 in the drone may provide location information to the drone processor 324 as well as altitude information. In addition, or alternatively, altitude information may be provided to the drone processor 324 by one or more altimeters 332 in the drone 204. An altimeter may be instantiated by a magnetic compass and/or barometer. Moreover, the speed of the drone 204 may be reflected in the signals from the drone GPS receiver 328 or the drone processor 324 may calculate speed using location signals from the drone GPS receiver 328 and time information from the clock 330. Yet again, in addition or alternatively, speed information may be provided to the drone processor 324 by one or more speed or velocity sensors 334 in the drone 204.

The drone processor 324 moves the control surfaces and engine or motor of the drone 204 in accordance with commands from the drone controller 202 by means of control circuitry 336. Further, the drone 204 may also include one or more Wi-Fi transceivers 338 and/or one or more Bluetooth transceivers 340.

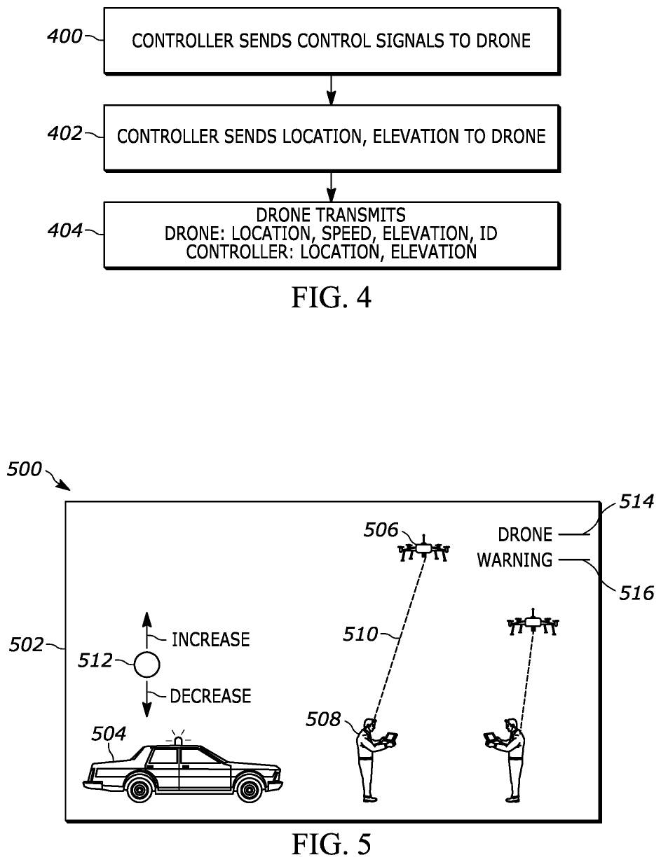

With the architectures of FIGS. 1-3 in mind, attention is now drawn to FIG. 4. Commencing at block 400, the drone controller 202 sends flight control signals to the drone 204 typically via the controller rf transceiver 314 communicating with the drone rf transceiver 322 as input by the user 200 via any of the input techniques described herein. The flight control signals are typically formatted as control packets. However, in some embodiments flight control signals may be sent via the Bluetooth and/or Wi-Fi transceiver.

Proceeding to block 402, the drone controller 202 also sends its location and elevation information along with time indications correlated to those indications to the drone 204. These signals may be sent over any of the one or more drone controller transmitters shown in FIG. 3. The signals typically may be sent as GPS packets.

In turn, at block 404 the drone 204 transmits, typically via its Bluetooth transmitter 340 and/or Wi-Fi transmitter 338, both the controller 200 and drone 204 GPS coordinates. In addition to location information, the data sent by the drone 204 may also include drone ID, drone altitude, drone velocity, drone controller 200 elevation, a time mark, and the emergency status, if any, of the drone. The drone ID may be unique to the drone and/or may include an ID of a registered owner of the drone.

The transmission of data at block 404 may occur periodically and automatically. For example, the transmission of data at block 404 may occur as soon as the processor in the drone receives a signal representing take-off of the drone into flight, and every N seconds thereafter.

In addition, or alternatively, the transmission of data at block 404 may occur only responsive to a command from an external device to transmit the data. The transmission of data at block 404 may occur substantially continuously throughout the flight of the drone. The transmission of data at block 404 may occur only responsive to the drone being at or above a certain altitude, or at or below a certain altitude. The transmission of data at block 404 may occur only responsive to the drone being at or above a certain speed, or at or below a certain speed. The transmission of data at block 404 may occur only responsive to the drone being at or within a certain distance of a given location, or at or outside a certain distance of a given location. Combinations of the above may be used.

In example implementations, some, or all of the information above sent from the controller to the drone may be in digital packets, each with their own universally unique identifier (UUID), and the drone processes only process packets with respective UUIDs. A 16-channel data path may be used with pulse width modulation (PWM) values for drone control commands for the drone servos that control the control surfaces of the drone.

In one example, every packet of drone control data that is sent may include the GPS coordinates of the controller. As the drone receives a packet, it processes the demanded servo positions, then reads its own GPS location and broadcasts a 2.4 GHz data packet (e.g., over Bluetooth and/or Wi-Fi) that includes both the GPS location of the drone and that of the controller (base station).

In some examples, the data packets from the drone (and/or from the controller to the drone) may be incorporated into a block chain to ensure a hacker cannot falsify another person's controller and drone to make it appear as if that other person were located at a spot they are not at. Further, the identity of the registered owner of the drone may also be part of the block chain. Each packet may be and individual block of the block chain. Top decode a packet, the block representing that packet is decoded. In this way, an encryption technique is established similar to a virtual private networks (VPN). In addition, or alternatively, standard encryption may be used on the packets and/or blocks of the block chain, such as 128- or 256-bit advanced encryption standard (AES).

FIG. 5 illustrates a user interface (UI) 500 that may be presented on a display 502 such as any of the displays herein. Information transmitted from drones in accordance with present principles may be collected by ground receivers and sent to a database that, for example, is accessible to law enforcement personnel. The UI 500 illustrates an origination icon 504 to indicate the location of a viewer such as a police officer's phone or other computer. The origination icon is an example of an indication of an origin indicating the location of the phone/computer and its display. The origin may be in the center of the UI. The indication may be simply centering the UI on the location of the phone/computer of the police officer.

Also, one or more drone icons 506 are presented indicating real time locations and other information (e.g., altitude) of drones as sent from the database and/or as sent direct from the drones via Bluetooth or Wi-Fi to the police device. Also, operator icons 508 indicate locations of the respective controllers of the drones, with lines 510 if desired presented to indicate what operators are correlated to what drones. The UI 500 may present only drones and operators within a threshold distance of the origination (police) location, e.g., within two miles. A selector 512 may be presented and can be manipulated to increase or decrease the threshold distance.

As shown in FIG. 5, the UI 500 may include a selector 514 to indicate a drone whose operator the police officer wishes to communicate with. While shown separately in FIG. 5 for ease of description, the selector 514 may be instantiated by simply touching one of the drone icons 506 or operator icon 508 on the UI 500 to indicate that the operator associated with the touched icon is desired to be communicated with.

A warning selector 516 also may be provided to enable the police officer to enter a warning or other message to be sent to the selected drone/operator. In one embodiment, the warning selector 516 may include a drop-down menu of typical warnings, such as “you need to bring it in”, “entering restricted airspace”, etc. Or the officer may enter a custom message.

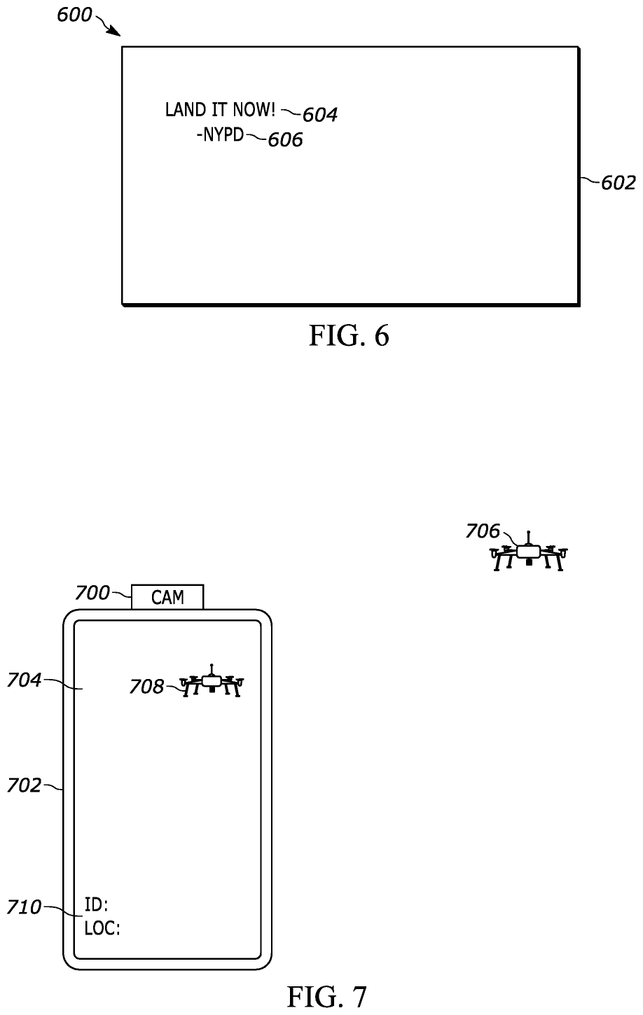

FIG. 6 illustrates a UI 600 that may be presented on a display 602 such as any of the displays herein for viewing by a drone operator on, e.g., his or her controller. A message 604 may be presented along with an identification 606 of the agency sending the message 604.

FIG. 7 shows a related technique in which a camera 700 on a law enforcement mobile device 702 with display 704 images one or more nearby drones 706, to present an image 708 of the imaged drones on the mobile device. An app on the mobile device that receives the Bluetooth/Wi-Fi drone ID signals discussed herein can determine the ID of the imaged drone based on its imaged location using orientation and location sensors in the mobile device and the relative location of the drone 706 with respect to the mobile device. Once the drone 706 (and its image 708 on the mobile device) is correlated to the associated drone ID information received from the drone, it is presented at 710 on the mobile device. A warning selector such as the selector 516 shown in FIG. 5 also may be provided to enable the police officer to enter a warning or other message to be sent to the selected drone/operator.

In addition to the drone ID data transmitted by the drone as described above, it is to be understood that other data that also may be reported, such as a picture of the drone itself to the mobile device so people receiving the broadcast can more easily ID an offending drone.

Present principles may be connected to computer games which combine the adventure of free flight with the thrill of high-speed racing. Selection from between different flight modes may be made to guide new players from novice flyers to professional drone pilots. This can enable qualification for real life drone racing events like the Drone Champions League (DCL) by enabling online play with pilots all over the world. Freestyle pilots, camera drone operators, and drone racing pilots are contemplated. Furthermore, present principles apply to theme parks where drones are used, such as for long-range events where no fences restrict the drones, but the operator still requires a way to flag drones outside of the safety zone and detract points from a score or warn them. Notifications of such may be presented on a user's head-mounted display (HMD) or goggles.

It will be appreciated that whilst present principals have been described with reference to some example embodiments, these are not intended to be limiting, and that various alternative arrangements may be used to implement the subject matter claimed herein.

What is claimed is:

1. An assembly, comprising:
at least one computer storage that is not a transitory signal and that comprises instructions executable by at least one processor to:
present on at least one display at least one user interface (UI) comprising at least one drone icon indicating at least a real time location of at least a first unmanned airborne drone;
present on the UI at least one operator icon indicate at least a real time location of a respective first controller of the first drone; and
present on the UI at least one warning selector selectable to enable the viewer to enter at least one message to be sent to at least the first controller.

2. The assembly of claim 1, wherein the instructions are executable to:
present on the UI visible indication correlating the drone icon and the respective operator icon.

3. The assembly of claim 2, wherein the visible indication comprises at least a portion of a line.

4. The assembly of claim 1, wherein the instructions are executable to:
present on the UI an origin indication to indicate a location of a viewer of the display;
present on the UI plural drone icons representing respective drones within a distance of the origin and not presenting icons representing drones beyond the distance.

5. The assembly of claim 4, wherein the instructions are executable to:
present on the UI at least a first selector selectable to establish the distance.

6. The assembly of claim 1, wherein the instructions are executable to:
present on the UI at least one drone selector mechanism selectable to indicate a drone whose respective operator is to receive the message.

7. The assembly of claim 1, wherein the instructions are executable to:
present an indication of altitude of the first drone.

8. The assembly of claim 1, wherein the instructions are executable to:
receive drone location information from a database.

9. The assembly of claim 1, wherein the instructions are executable to:
receive drone location information from a drone.

10. The assembly of claim 1, comprising the at least one processor executing the instructions.

11. An assembly comprising:
drone controller comprising at least one location sensor and at least one wireless transceiver, and at least one controller processor, the drone controller being associated with at least one display;
at least one drone comprising at least one location sensor, at least one information transmitter, and at least one drone processor to control flight of the drone responsive to signals from the drone controller, wherein the controller processor is programmed with instructions to:
present on the display at least one user interface (UI) comprising at least message regarding operation of the drone and at least one identification of an agency sending the message.

12. An assembly, comprising:
at least one computer storage that is not a transitory signal and that comprises instructions executable by at least one processor to:
present on at least one display at least one user interface (UI) comprising at least one image from at least one camera of at least a first airborne pilotless drone;
receive via Bluetooth and/or Wi-Fi at least one signal from the first drone indicating at least a drone ID of the first drone;
correlate the drone ID with the first drone in the image at least in part based on the image using orientation and location sensors in the mobile device; and
present information associated with the drone ID on the display.

13. The assembly of claim 12, comprising the at least one processor executing the instructions.

14. The assembly of claim 12, wherein the camera is supported on a law enforcement mobile device comprising the display.

15. The assembly of claim 12, wherein the instructions are executable to:
present on the display at least one warning selector to enter a warning or other message to be sent to the first drone.

16. The assembly of claim 12, wherein the information associated with the drone ID comprises a picture of the first drone not received from the camera.

17. The assembly of claim 12, wherein the information associated with the drone ID comprises altitude of the first drone.

18. The assembly of claim 12, wherein the information associated with the drone ID comprises location of the first drone.

19. The assembly of claim 12, wherein the information associated with the drone ID comprises location of an operator of the first drone.
